(19) United States
(12) Patent Application Publication
(10) Pub. No.: US 2007/0232142 A1
(43) Pub. Date: Oct. 4, 2007

(54) Locking Device for Patchcord

(75) Inventors: Alain Desrochers, Laval (CA); Yannick Demers, Montreal (CA)

Correspondence Address: AKERMAN SENTERFITT, P.O. BOX 3188, WEST PALM BEACH, FL, 33402-3188, US

(73) Assignee: Belden CDT Canada Inc., Pointe-Claire (CA)

(21) Appl. No.: 11/695,178

(22) Filed: Apr. 2, 2007

Related U.S. Application Data
(60) Provisional application No. 60/787,658, filed on Mar. 31, 2006.

(51) Int. Cl. H01R 13/648

(52) U.S. Cl. 439/607

(57) ABSTRACT

There is provided a device and method for coded securing of a modular plug in a modular receptacle, in particular an RJ-45 plug in a RJ-45 receptacle, the receptacle comprising a front face defining an aperture and the plug comprising a plug body having dimensions substantially the same as those of the aperture and an elongate latch flexibly attached at a first end towards a front end of the plug body and comprising a release lever at a second end thereof and at least one latch tab positioned between the first end and the second end, the second end of the latch biased normally away from the plug body such that when the front end of the plug is inserted into the aperture into an engaged position the at least one latch tab engages an inside of the front face and is retained therein until the plug is released from the engaged position by depressing the release lever. The device comprises a ring or clip comprising a blocking portion having a width substantially the same as a distance between the release lever and the plug body when in the engaged position and defining an aperture having dimensions substantially the same as those of the receptacle aperture, the ring configured for placement over the plug body, and a coding means incorporated into the ring. When the plug is in the engaged position the ring is installed around the plug body flush against the front face with the blocking portion positioned between the release lever and the plug body, thereby preventing the release lever from being depressed sufficiently to release the plug from the receptacle.

### CROSS REFERENCE TO RELATED APPLICATIONS

This application claims priority on U.S. provisional application No. 60/787,658, filed on Mar. 31, 2006 which is incorporated herein in its entirety by reference.

### FIELD OF THE INVENTION

The present invention relates to a locking device for a patch cord. In particular, the present invention relates to a retrofitable lock clip or ring which when installed on a connector plug engaged in a receptacle prevents a release lever from being depressed while simultaneously providing a means for coding the interconnection between plug and receptacle.

### BACKGROUND

In a networking environment, patchcords (such as 8Mod patchcords terminated with RJ-45 compatible plugs) are used to interconnect active equipment (such as computers, servers, switches, and the like), cross connecting equipment (such as patch panels, mini racks, cable management systems, and the like) and other required equipment for the transmission of voice and data. Patch cords are used in public, data center and telecom room environments.

The growth in current data networking is calling for increased identification of patch cord connections and protection within the same limited space, hence a trend toward higher density and more compact installations.

One drawback with prior art patchcords is that, although equipped with a simple system for interlocking the plug with a corresponding receptacle, they can be easily disconnected, either inadvertently or advertently (for example by those who maliciously wish to interfere with data communications). Additionally, although patchcords can be purchased in a variety of colours, in many cases patchcords are of the same or similar colour and no mechanism is provided for differentiating between two different patch cords.

### SUMMARY OF THE INVENTION

In order to address the above and other drawbacks there is provided a device for securing a modular plug in a modular receptacle, in particular an RJ-45 plug in a RJ-45 receptacle, the receptacle comprising a front face defining an aperture and the plug comprising a plug body terminating a cable and having dimensions greater than those of the aperture, an inserting part attached to said plug body and having dimensions substantially the same as those of the aperture and adapted for insertion therein, and an elongate latch flexibly attached at a first end towards a front end of the inserting part and comprising a release lever at a second end thereof and at least one latch tab positioned between the first end and the second end, the second end of the latch biased normally away from the inserting part such that when the inserting part is inserted into the aperture into an engaged position the at least one latch tab engages an inside of the front face and is retained therein until the plug is released from the engaged position by depressing the release lever. The device comprises a ring comprising a blocking portion having a width substantially the same as a distance between the release lever and the inserting part when in the engaged position and defining an aperture having dimensions substantially the same as those of the receptacle aperture, the ring configured for placement over the inserting part, and a coding means incorporated into the ring. When the plug is in the engaged position the ring is installed around the inserting part with the blocking portion positioned between the release lever and the plug body, thereby preventing the release lever from being depressed sufficiently to release the plug from the receptacle and further wherein the plug body limits displacement of said ring away from the front face such that said blocking portion remains between the release lever and the plug body.

There is also disclosed a method for securing a modular plug in a modular receptacle, in particular an RJ-45 plug in a RJ-45 receptacle, the receptacle comprising a front face defining an aperture and the plug comprising a plug body having dimensions substantially the same as those of the aperture and an elongate latch flexibly attached at a first end towards a front end of the plug body and comprising a release lever at a second end thereof and at least one latch tab positioned between the first end and the second end, the second end of the latch biased normally away from the plug body such that when the front end of the plug is inserted into the aperture into an engaged position the at least one latch tab engages an inside of the front face and is retained therein until the plug is released from the engaged position by depressing the release lever. The method comprises inserting the plug in the receptacle into the engage position, providing a length of material separating interlocking ends, the length comprising a blocking portion having a thickness substantially the same as a distance between the release lever and the plug body when in the engaged position, wrapping the length around the plug body, positioning the blocking portion between the release lever and the plug and interlocking the ends.

Also, there is disclose a device for securing a modular plug in a modular receptacle, in particular an RJ-45 plug in a RJ-45 receptacle, the receptacle comprising a front face defining an aperture and the plug comprising a plug body terminating a cable and having dimensions greater than those of the aperture, an inserting part attached to the plug body and having dimensions substantially the same as those of the aperture and adapted for insertion therein, and an elongate latch flexibly attached at a first end towards a front end of the inserting part and comprising a release lever at a second end thereof and at least one latch tab positioned between the first end and the second end, the second end of the latch biased normally away from the inserting part such that when the inserting part is inserted into the aperture into an engaged position the at least one latch tab engages an inside of the front face and is retained therein until the plug is released from the engaged position by depressing the release lever. The device comprises first and second opposed and generally parallel members and a cross member interconnecting a first end of the first member with a first end of the second member, the members defining a region for receiving the inserting part there between, one of the opposed members comprising a blocking portion having a width substantially the same as a distance between the release lever and the plug body when in the engaged position. When the plug is in the engaged position, the device is installed such that at least a portion of the inserting part is located within the region with the blocking portion positioned between the release lever and the plug body, thereby preventing the release lever from being depressed sufficiently to disengage the latch tab from the front face and release the plug from the receptacle and further wherein the plug body limits displacement of the ring away from the front face such that the blocking portion remains between the release lever and the plug body.

### BRIEF DESCRIPTION OF THE FIGURES

FIG. 1 is a raised front view of a locking device in accordance with an illustrative embodiment of the present invention;

FIG. 2 is a front plan view of a locking device in accordance with an illustrative embodiment of the present invention;

FIG. 3 is a partial sectional view along line 3-3 in FIG. 1;

FIG. 4 is a raised front view of a locking device mounted on a cable plug inserted in a receptacle in accordance with an illustrative embodiment of the present invention;

FIG. 5 is a lowered front view of a locking device mounted on a cable plug inserted in a receptacle in accordance with an illustrative embodiment of the present invention;

FIG. 6 is a sectional view along VI in FIG. 5;

FIG. 7 is a raised front view of a locking device in accordance with a first alternative illustrative embodiment of the present invention;

FIG. 8 is a front plan view of a locking device in accordance with a first alternative illustrative embodiment of the present invention;

FIG. 9 is a raised front view of a lock ring mounted on a cable plug inserted in a receptacle in accordance with a first alternative illustrative embodiment of the present invention;

FIG. 10 is a sectional view along line X-X in FIG. 7;

FIG. 11 provides a rear isometric view (from below) of a locking device and connector plug in accordance with a second illustrative embodiment of the present invention;

FIG. 12 provides a front isometric view (from above) of the locking device of FIG. 11 assembled on the connector plug;

FIG. 13 provides a rear isometric view (from below) of a locking device and connector plug in accordance with a first variant of a second illustrative embodiment of the present invention;

FIG. 14 provides a front isometric view (from above) of the locking device of FIG. 13 assembled on the connector plug;

FIG. 15 provides a front isometric view (from below) of a locking device and connector plug in accordance with a second variant of a second illustrative embodiment of the present invention; and

FIG. 16 provides a front isometric view (from above) of the locking device of FIG. 15 assembled on the connector plug.

### DETAILED DESCRIPTION OF THE ILLUSTRATIVE EMBODIMENTS

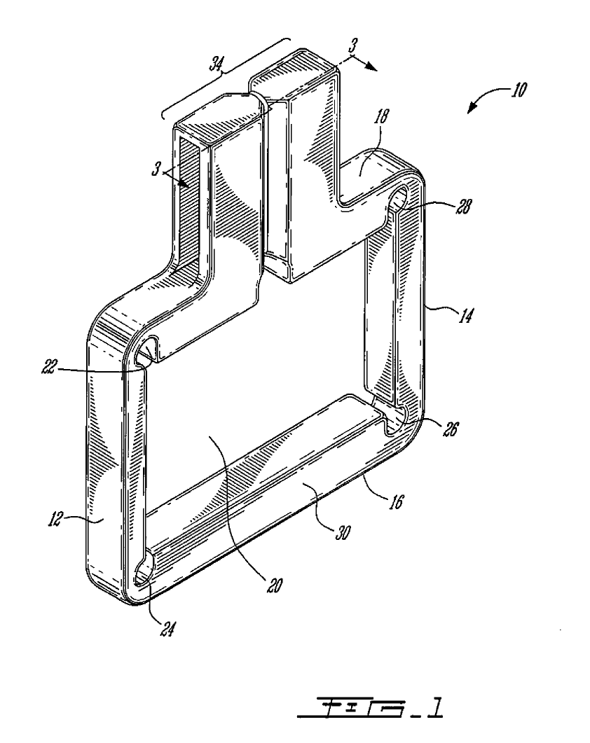

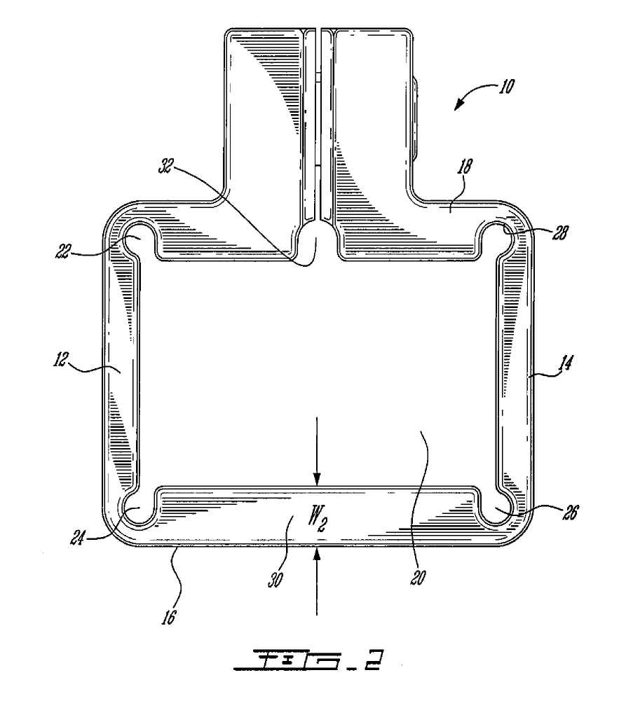

Referring now to FIGS. 1 and 2, a locking device for a patchcord in accordance with a first illustrative embodiment of the present invention and generally referred to using the reference numeral 10, will now be described. The locking device 10 comprises two short elongate sections as in 12, 14 and two long elongate sections as in 16, 18 defining a rectangular aperture 20 and interconnected by flexible articulating regions 22, 24, 26 and 28 which allow the elongate sections 12, 14, 16 and 18 to articulate relative to one another. A first elongate section 16 comprises a blocking portion 30 midway along the first elongate section 16. A second elongate portion 18 includes a bifurcation 32 at a predetermined position typically midway along the second elongate portion 18. A locking mechanism 34 is provided in order to allow the ends of the bifurcated second elongate portion 18 to be securely interlocked. The aperture 20 defined by the elongate sections 12, 14, 16 and 18 is configured to snugly fit a cable plug housing (not shown).

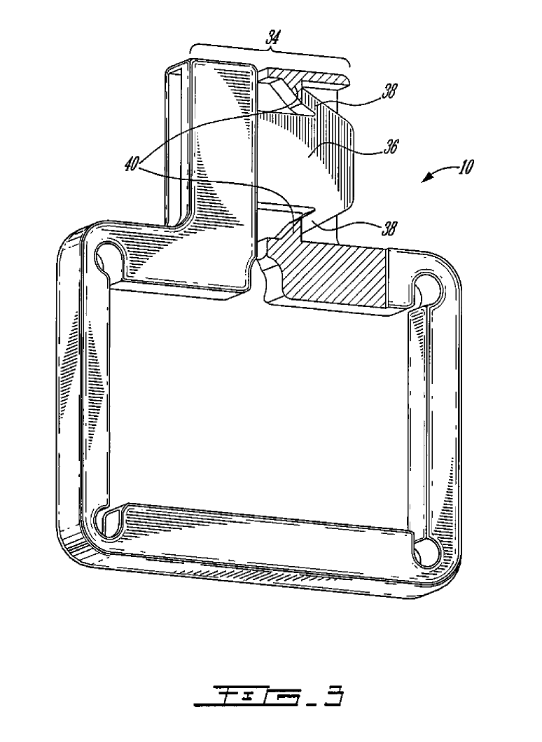

Referring now to FIG. 3, the locking mechanism 34 illustratively comprises a male latch portion 36 comprising a pair of latches 38 which is inserted into a female covered latch receiving portion. On insertion into the latch receiving portion, the pair of latches 38 interlock with a corresponding pair of strike plates 40 thereby retaining the latch portion 36 within the latch receiving portion. In order to disengage the pair of latches 38 from the pair of strike plates 40 a special tool (not shown) must be used. The tool is used to depress the pair of latches 38 such that they clear the pair of strike plates 40, thereby allowing the latch portion 36 to be retracted from the latch receiving portion.

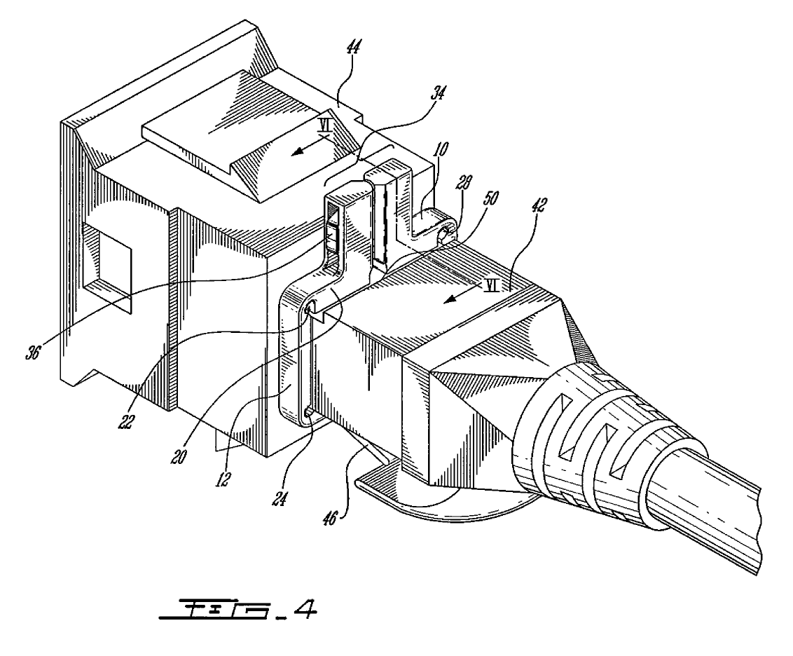

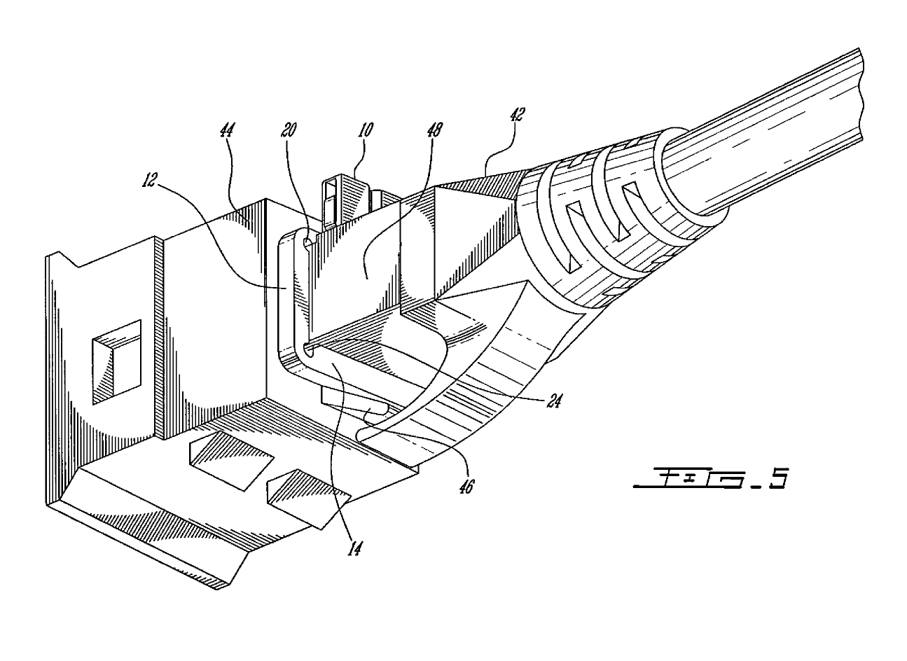

Referring now to FIGS. 4 and 5, the locking device 10 is typically installed in the cable plug 42 after the cable plug 42 has been mated with a receptacle 44 and the locking tab/release lever 46 engaged (although with many cable plugs as in 42 the locking device 10 can be preinstalled, the flexibility of the locking tab/release lever 46 such that the cable plug 42 can be inserted into the receptacle but its removal prevented). As discussed above in reference to FIGS. 1 and 2, the elongate sections as in 12, 14, 16 and 18 are illustratively interconnected by the articulating regions 22, 24, 26 and 28 which allow the elongate sections 12, 14, 16, and 18 to articulate relative to one another. In an alternative embodiment, the locking device 10 could be manufactured from a resilient yet flexible material, allowing the elongate sections 12, 14, 16, and 18 to be bent relative to one another. Using this feature, the locking device 10 is opened and placed around the cable plug 42 in the manner indicated, while ensuring that the lower elongate section 14 is situated between the locking tab/release lever 46 and the cable plug 42. The locking mechanism 34 is then engaged by inserting the latch portion 36 into the latch receiving portion, thereby locking the locking device 10 about the cable plug 42.

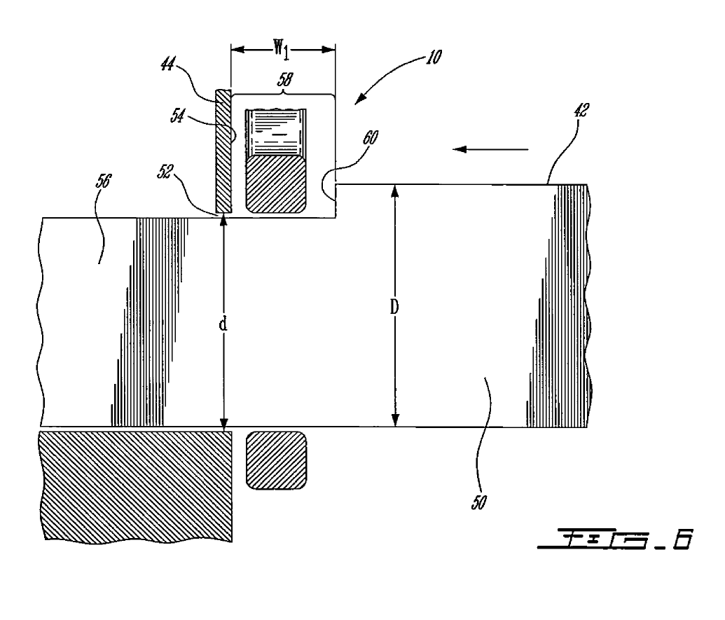

Referring now to FIG. 6 in addition to FIGS. 4 and 5, as known in the art, conventional cable plugs as in 42 are typically comprised of a cable receiving plug body 50 having transverse cross sectional dimension “D” somewhat larger than the cross sectional dimension “d” of the aperture 52 defined by the front face 54 of the receptacle 44. An insertion part 56 of the cable plug 42 is adapted for insertion into the aperture 52 and therefore has the same general transverse cross sectional dimensions as the aperture 52 (albeit slightly smaller so the inserting part 56 can be received within the aperture 52). The inserting part 56 is somewhat longer than the depth of the receptacle 44 such that when the cable plug 42 is engaged within the receptacle 44, a gap 58 having width W₁ is formed between the front face 54 of the receptacle 44 and the raised forward edge 60 of the plug body 50.

Still referring to FIG. 6, as will now be apparent to a person of ordinary skill in the art, when the locking device 10 is installed about an inserting part 56 of the cable plug 42 with at least a portion of the locking device 10 in the gap 58, movement of the locking device 10 away from the front face 54 of the receptacle 44 is limited by the raised forward edge 60 of the plug body 50.

Referring back to FIG. 2 and FIG. 5, the blocking portion 30 has width W₂ which is sufficient to prevent the locking tab/release lever 46 from being actuated or depressed which, as will now be apparent to a person of skill in the art, prevents the cable plug 42 from being disengaged from the receptacle 44. As the locking device 10 is only removable using a suitable tool (or by cutting or breaking or the like) the cable plug 42 is held effectively within the receptacle 44.

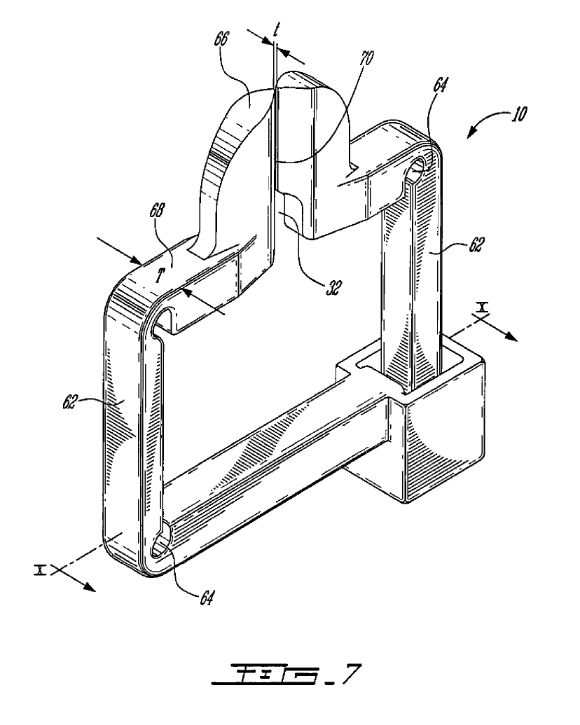

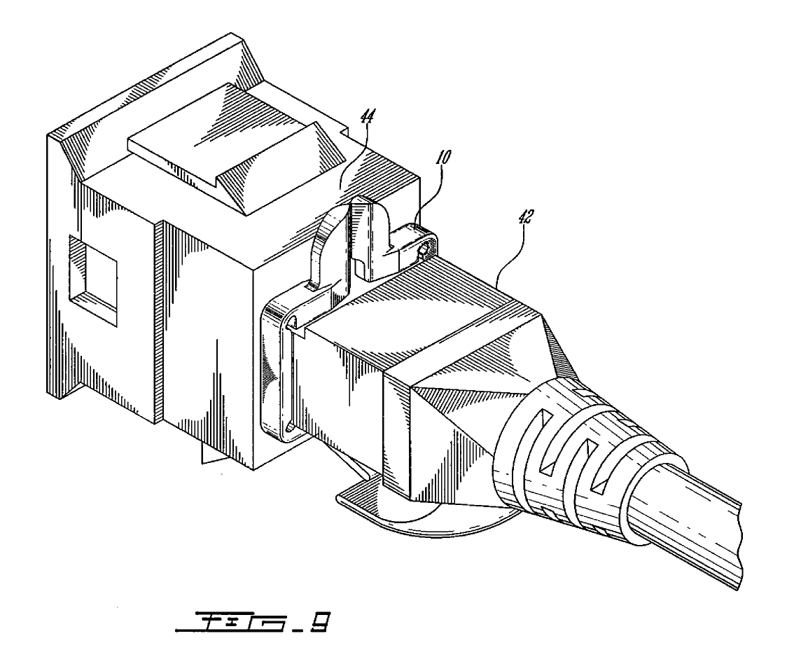

Referring now to FIGS. 7, 8 and 9, a first alternative illustrative embodiment of a locking device 10 is disclosed. Similar to the locking device 10 of the first illustrative embodiment, the locking device 10 of the alternative illustrative embodiment is comprised of a series of elongate sections as in 62 which are interconnected by a series of articulating regions as in 64. The articulating regions as in 64 allow the elongate sections as in 62 to articulate relative to one another, thereby allowing the locking device 10 to be installed onto a cable plug 42. The first long elongate segment 62₁ comprises a blocking portion 30 approximately midway along its length and having a width W₁ which is sufficient to prevent the locking tab/release lever 46 from being actuated or depressed. Additionally, the second long elongate section 62₂ comprises a bifurcation 32 which is spanned by a tab 66 attached along the outer edge 68 of the second long elongate section 62₂. The tab 66 is frangible, for example by providing a notch 70 having a thickness t less than a thickness T of the second long elongate section 62₂ along a centre line thereof and arranged at right angles to the second long elongate section 62₂. Alternatively, the notch 70 can be used to guide a cutting tool (not shown) such as cutters or the like, which are used to separate the second long elongate section 62₂ in two, thereby allowing the locking device 10 to be removed from the cable plug. The notch 70 also provides the advantage of holding the surface of the tab 66 away from the outer surface of receptacle (not shown) thereby allowing a cutting tool (also not shown) to be at least partially inserted between the tab 66 and the outer surface of receptacle.

In a particular embodiment the tab 66 can also serve as a convenient location for identifying the connector plug/receptacle interconnection, for example by providing a convenient location for adhering identification labels, by embossing the tab 66 with a suitable label or colouring the tab 66 with a distinctive colour.

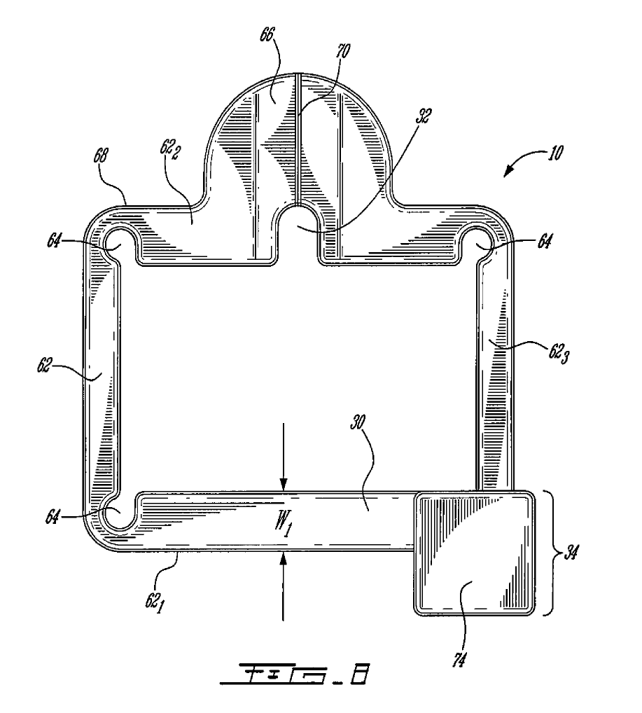

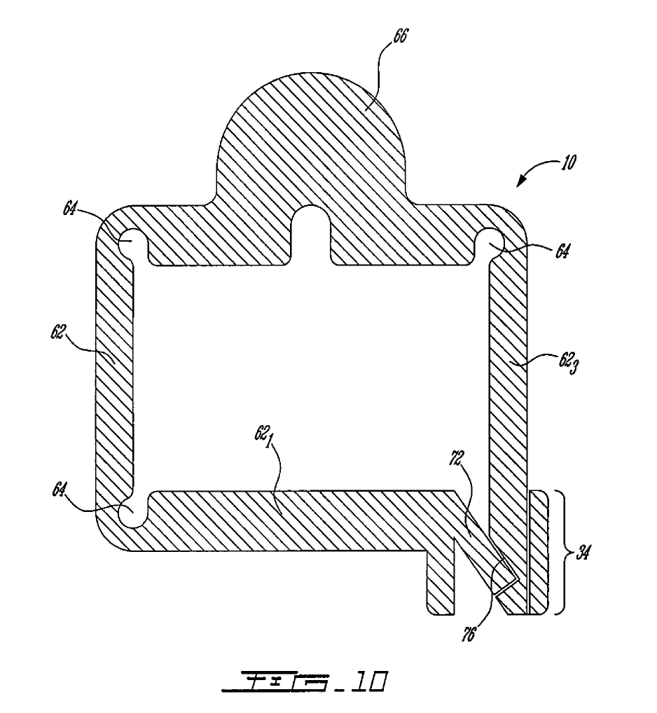

Referring now to FIGS. 8 and 10, a second illustrative embodiment of the locking mechanism 34 comprises a flexible latch 72 which is retained within a covered region 74 at the end of one a first of the elongate supports 62₁. As the end of a third of the elongate supports 62₃ is inserted into the covered region 74 a slot 76 formed in the end of the second of the elongate supports 62₃ is engaged by the latch 72, thereby securing the ends of the elongate supports 62₁ and 62₃ together. As will now be apparent to a person of ordinary skill in the art, once the locking mechanism 34 is engaged the latch 72 cannot be disengaged from the slot 66.

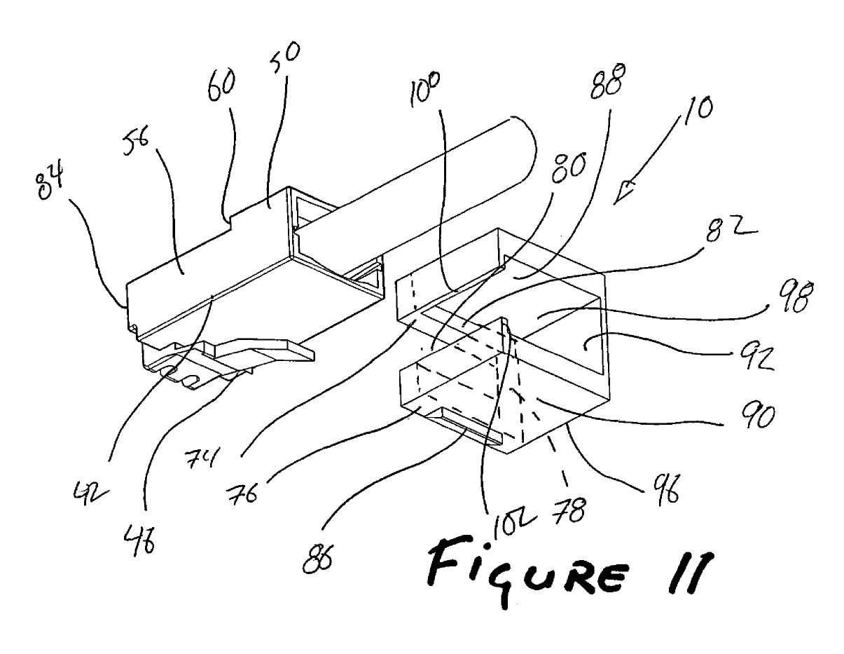

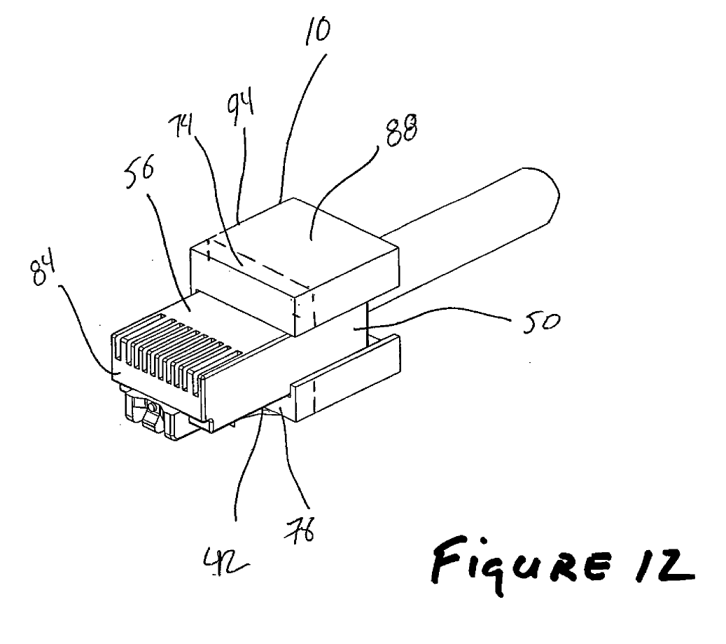

Referring now to FIGS. 11 and 12, a second alternative illustrative embodiment of the locking device 10 is of generally “C” shaped cross section and comprises first and second opposed and generally parallel members 74, 76 which are interconnected at a first end by a cross member 78. The members 74, 76 and 78 define a region 80 which is dimensioned to receive the inserting part 56 of the cable plug 42 there between. Similar to the other illustrative embodiments locking devices 10 as described hereinabove, when the locking device 10 is installed on the cable plug 42, the raised forward edge 60 of the plug body 50 engages an inside edge 82 of the first member 74 thus limiting displacement of the locking device 10 away from the front end 84 of the cable plug 42 thus ensuring that the blocking portion 86, positioned midway along the second member, remains positioned between the inserting part 56 and the locking tab/release lever 46. In this regard, the blocking portion 86 can be profiled, illustratively with a generally triangular cross section, such that it better engages the locking tab/release lever 46.

Still referring to FIGS. 11 and 12, the locking device 10 illustratively further comprises sheets as in 88, 90, 92 attached to each of the first and second members 74, 76 and the cross member 78. Adjacent ones of the sheets 88, 90, 92 are interconnected along their edges as in 94, 96 and define a plug body receiving region 98 there between. As will now be apparent to one of skill in the art, when the locking device is installed on the cable plug 42 (as illustrated in FIG. 12), the plug body 50 is positioned within the plug body receiving region 98. Of note is that the locking device 10 is typically manufactured from a single piece of material using a moulding process. Additionally, raised edges or protuberances 100, 102 may be added to the outer free edges of the opposed sheets 88, 92 in order to better retain the plug body 50 within the plug body receiving region 98 by mechanical interlock between the inner surfaces of the protuberances 100, 102 and the plug body 50.

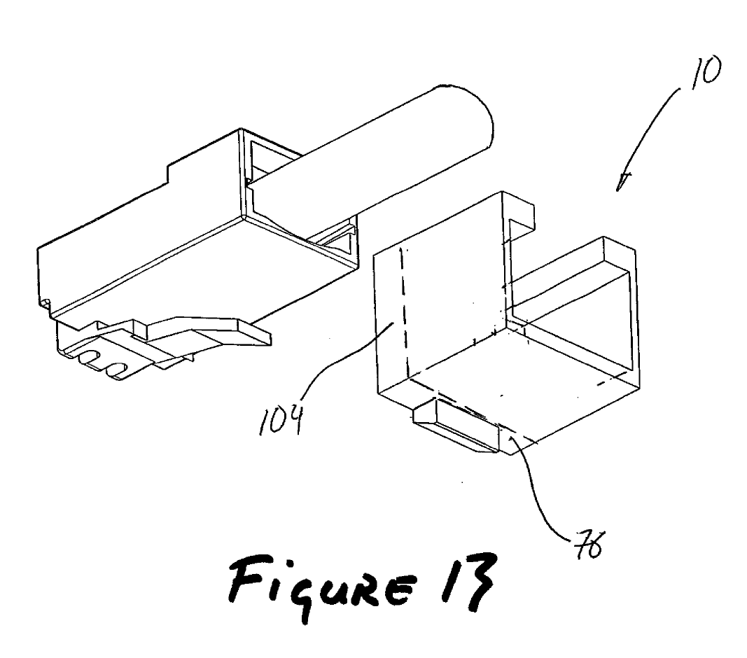

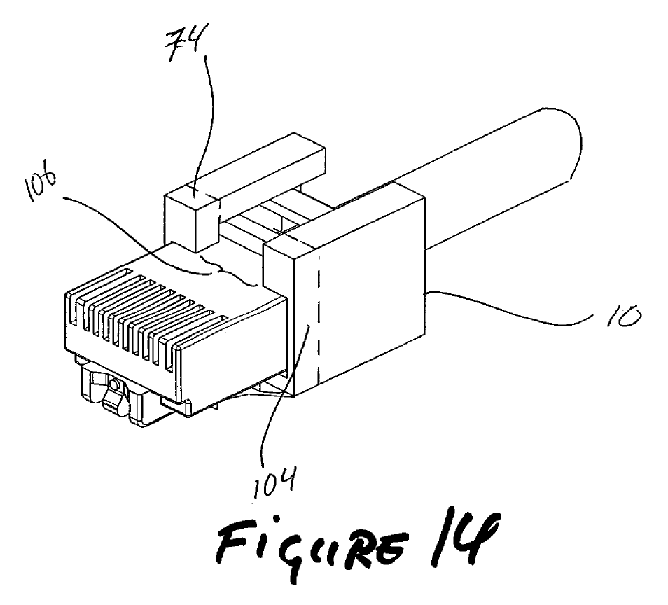

Referring now to FIGS. 13 and 14, in a first variant of the second alternative illustrative embodiment of a locking device 10, a second cross member 104 interconnects the first and second opposed members 74, 76. Additionally, the first opposed member 74 includes a bifurcation 106.

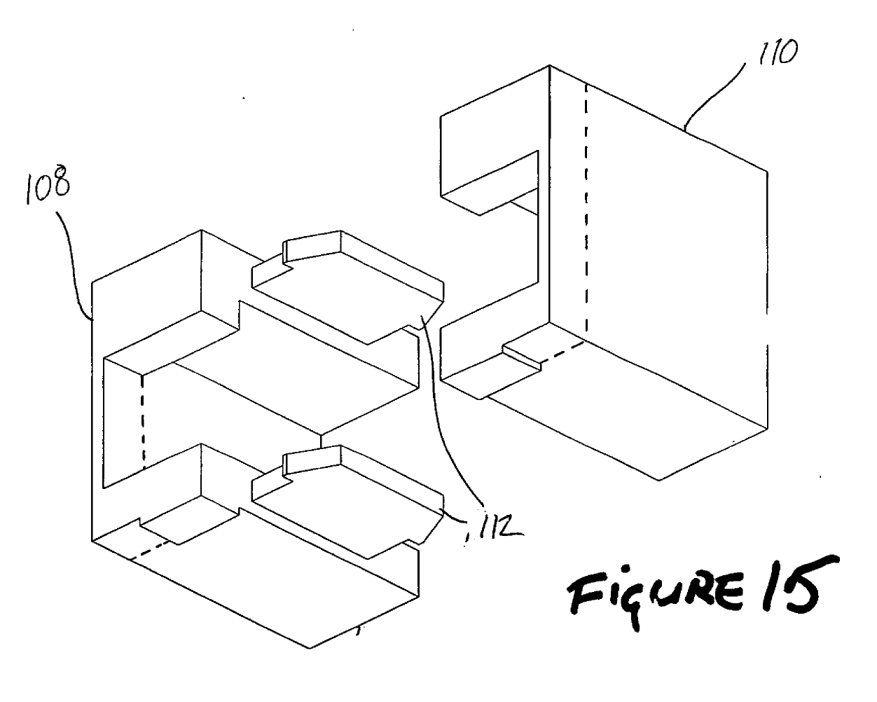

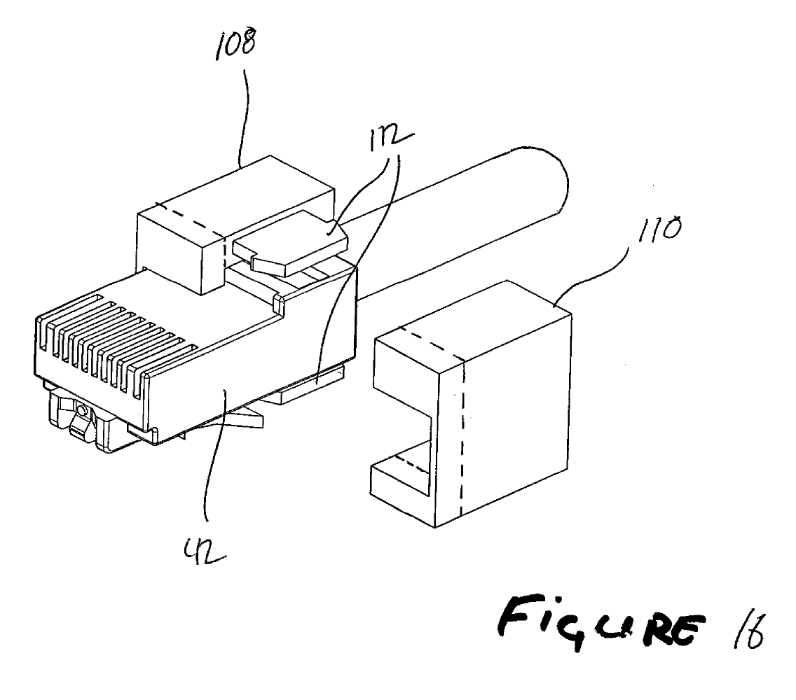

Referring now to FIGS. 15 and 16, in a second variant of the second alternative illustrative embodiment the locking device 10 is divided into first and second interlocking parts 108, 110. The first interlocking part illustratively comprises a pair of interlocking tabs 112 which are inserted into corresponding tab receiving slots (not shown) moulded or otherwise fashioned in the second interlocking part 110. Referring in particular to FIG. 16, in order to install the locking device 10 on the cable plug 42, the first interlocking part 108 is placed on the plug body, the second interlocking part 110 positioned such that the interlocking tabs 112 are aligned with the slots and the interlocking parts 108, 110 pressed together.

Of note is that the locking device 10 as described hereinabove can be manufactured in a variety of colours thereby providing an efficient retrofitable and interchangeable means for providing quick identification of a given cable. Additionally, the locking device 10 could also be adapted to provide identification space, for example for the addition of numbers of other identification schemes to the locking device 10.

As a result, the locking device 10 provides security against vandalism, prevention of accidental disconnections as well as a means to provide identification of a locked patch cord connection. The locking device 10 also in some embodiments provides a means for securing a cable plug within a receptacle which can only be removed by destroying the locking device 10. The locking device 10 can be manufactured from a rigid or flexible material depending on the intended application. Additionally, the locking device 10 can be install or removed with the use of a special tool without interrupting transfer of data over the existing equipment installation. An equivalent locking device 10 could also be incorporated either directly on the equipment or on the patch cord.

Although the present invention has been described hereinabove by way of an illustrative embodiment thereof, this embodiment can be modified at will without departing from the spirit and nature of the subject invention.

What is claimed is:

1. A device for securing of a modular plug in a modular receptacle, in particular an RJ-45 plug in a RJ-45 receptacle, the receptacle comprising a front face defining an aperture and the plug comprising a plug body terminating a cable and having dimensions greater than those of the aperture, an inserting part attached to said plug body and having dimensions substantially the same as those of the aperture and adapted for insertion therein, and an elongate latch flexibly attached at a first end towards a front end of the inserting part and comprising a release lever at a second end thereof and at least one latch tab positioned between the first end and the second end, the second end of the latch biased normally away from the inserting part such that when the inserting part is inserted into the aperture into an engaged position the at least one latch tab engages an inside of the front face and is retained therein until the plug is released from the engaged position by depressing the release lever, the device comprising:
a ring comprising a blocking portion having a width substantially the same as a distance between the release lever and the inserting part when in the engaged position and defining an aperture having dimensions substantially the same as those of the receptacle aperture, said ring configured for placement over the inserting part; and
a coding means incorporated into the ring;
wherein when the plug is in the engaged position said ring is installed around the inserting part with said blocking portion positioned between the release lever and the plug body, thereby preventing the release lever from being depressed sufficiently to release the plug from the receptacle and further wherein the plug body limits displacement of said ring away from the front face such that said blocking portion remains between the release lever and the plug body.

2. The device of claim 1, wherein said ring is fabricated from a length of material separating interlocking ends, and further wherein during installation said length of material is wrapped around the plug body and said ends interlocked.

3. The device of claim 2, wherein said interlocking ends can be released using a special tool.

4. The device of claim 2, wherein said interlocking ends cannot be released and wherein said length of material is frangible at a predetermined location.

5. The device of claim 4, wherein said ring is comprised of four interconnected segments defining a rectangular aperture, said blocking portion is positioned midway along a first long segment and said predetermined location is positioned midway along a second long segment.

6. The device of claim 5, wherein said second long segment is of reduced thickness at said predetermined location.

7. The device of claim 5, wherein said second long segment is bifurcated at said predetermined location and further comprising a tab attached along an outer edge of said second long segment spanning said bifurcation.

8. The device of claim 7, wherein said tab is substantially flat and wherein a thickness of said tab is less than a thickness of said second long segment.

9. The device of claim 8, wherein said tab is substantially flat and wherein a thickness of said tab is less than a thickness of said second long segment.

10. The device of claim 9, wherein said tab is frangible along a line intersecting said predetermined position.

11. The device of claim 9, further comprising a notch spanning said tab, said notch intersecting said bifurcation and at right angles to said second segment.

12. The device of claim 2, wherein said coding means comprises a distinctive colouring of said length of material.

13. The device of claim 2, wherein said ring is comprised of four interconnected segments defining a rectangular aperture, said blocking portion is positioned midway along a first long segment and further comprising a raised tab positioned midway along an outer edge of a second long segment.

14. The device of claim 13, wherein said identification means comprises attaching a distinctive label to said tab.

15. The device of claim 13, wherein said identification means comprises embossing said tab with a distinctive label.

16. The device of claim 13, wherein said identification means comprises colouring said tab a distinctive colour.

17. The device of claim 2, wherein said length of material is flexible.

18. The device of claim 2, wherein said length of material comprises at least one flexible joint therein.

19. The device of claim 2, further comprising a locking mechanism and wherein said ends are interlocked using said locking mechanism, said locking mechanism comprising a male part comprising a flexible latch and a female part comprising a strike plate wherein when said male part is inserted into said female part, said latch is engaged by said strike plate thereby retaining said male part in said female part.

20. The device of claim 19, wherein when inserted said male part is enclosed in said female part.

21. The device of claim 1, wherein said ring is comprised of four interconnected segments defining a rectangular aperture, said blocking portion is positioned midway along a first long segment, further comprising a bifurcation midway along a second long segment and a locking mechanism spanning said bifurcation, wherein a male part of said locking mechanism is attached along an outer edge of said second long segment on a first side of said bifurcation and a female part of said locking mechanism is attached along an outer edge of said second long segment on a second side of said bifurcation.

22. The device of claim 21, wherein said identification means comprises attaching a distinctive label to said locking mechanism.

23. The device of claim 21, wherein said identification means comprises embossing a distinctive label into said locking mechanism.

24. The device of claim 21, wherein said identification means comprises colouring said locking mechanism a distinctive colour.

25. A method for securing a modular plug in a modular receptacle, in particular an RJ-45 plug in a RJ-45 receptacle, the receptacle comprising a front face defining an aperture and the plug comprising a plug body having dimensions substantially the same as those of the aperture and an elongate latch flexibly attached at a first end towards a front end of the plug body and comprising a release lever at a second end thereof and at least one latch tab positioned between the first end and the second end, the second end of the latch biased normally away from the plug body such that when the front end of the plug is inserted into the aperture into an engaged position the at least one latch tab engages an inside of the front face and is retained therein until the plug is released from the engaged position by depressing the release lever, the method comprising:
inserting the plug in the receptacle into the engaged position;
providing a length of material separating interlocking ends, said length comprising a blocking portion having a thickness substantially the same as a distance between the release lever and the plug body when in the engaged position;
wrapping said length around the plug body;
positioning said blocking portion between the release lever and the plug; and
interlocking said ends.

26. The method of claim 25, wherein a first of said interlocking ends comprises a male part comprising a latch and a second of said interlocking ends comprises a female part comprising a strike plate and further wherein said interlocking act comprises inserting said male part into said female part such that said latch is engaged by said strike plate.

27. The method of claim 26, further comprising releasing said interlocking ends by depressing said latch using a special tool.

28. The method of claim 25, wherein a first of said interlocking ends comprises a male part comprising a notch and a second of said interlocking ends comprises a female part comprising a latch and further wherein said interlocking act comprises inserting said male part into said female part such that said notch is engaged by said latch.

29. A device for securing a modular plug in a modular receptacle, in particular an RJ-45 plug in a RJ-45 receptacle, the receptacle comprising a front face defining an aperture and the plug comprising a plug body terminating a cable and having dimensions greater than those of the aperture, an inserting part attached to said plug body and having dimensions substantially the same as those of the aperture and adapted for insertion therein, and an elongate latch flexibly attached at a first end towards a front end of the inserting part and comprising a release lever at a second end thereof and at least one latch tab positioned between the first end and the second end, the second end of the latch biased normally away from the inserting part such that when the inserting part is inserted into the aperture into an engaged position the at least one latch tab engages an inside of the front face and is retained therein until the plug is released from the engaged position by depressing the release lever, the device comprising:
first and second opposed and generally parallel members; and
a cross member interconnecting a first end of said first member with a first end of said second member, said members defining a region for receiving the inserting part there between, one of said opposed members comprising a blocking portion having a width substantially the same as a distance between the release lever and the plug body when in the engaged position;
wherein when the plug is in the engaged position, the device is installed such that at least a portion of the inserting part is located within said region with said blocking portion positioned between the release lever and the plug body, thereby preventing the release lever from being depressed sufficiently to disengage the latch tab from the front face and release the plug from the receptacle and further wherein the plug body limits displacement of said ring away from the front face such that said blocking portion remains between the release lever and the plug body.

30. The device of claim 29, further comprising a plurality of sheets, one of each of said sheets attached to each of said first and second members and said cross member, each of said sheets interconnected with at least one adjacent sheet along an edge thereof and defining a plug body receiving region there between, and wherein when the device is installed on the plug with said blocking portion positioned between the release lever and the plug body, said plug body is positioned in said plug body receiving region.

31. The device of claim 30, wherein said sheets and said members are moulded from a single piece of a dielectric material.

32. The device of claim 29, further comprising a second cross member interconnecting a second end of said first member with a second end of said second member, said first and second members and said first and second cross members defining an aperture having dimensions substantially the same as those of the receptacle aperture and further wherein said second member is bifurcated midway between said first end and said second end.

33. The device of claim 29, further comprising a second cross member interconnecting a second end of said first member with a second end of said second member, said first and second members and said first and second cross members defining an aperture having dimensions substantially the same as those of the receptacle aperture and further wherein the device is installed on the inserting part by first separating the device transversely into two parts between said first end and said second end of each of said first and second members and then reassembling said two parts about the inserting part.

34. The device of claim 29, wherein a length of each of said opposed members is greater than a width of said inserting part and each of said opposed members comprises a protuberance protruding into said region towards a second end thereof such that when the device is installed on the plug, said inserting part is retained within said region through mechanical interlock between said cross member, said raised protuberances and the inserting part.

35. The device of claim 29, wherein the device is retained to the plug using a friction fit between an inner surface of said opposed members and the inserting part.

36. The device of claim 29, further comprising a coding means incorporated into the clip.

37. The device of claim 36, wherein said coding means comprises a distinctive colouring of at least a portion of the clip.

38. The device of claim 36, wherein said first member comprises said blocking portion and further wherein said coding means comprises an identification tab attached along an outer edge of said second member.
